(19) United States
(12) Patent Application Publication
(10) Pub. No.: US 2026/0147980 A1
(43) Pub. Date: May 28, 2026

(54) GENERATIVE ARTIFICIAL INTELLIGENCE MODEL EVALUATION

(71) Applicant: Microsoft Technology Licensing, LLC, Redmond, WA (US)

(72) Inventors: Hadas BITRAN, Ramat Hasharon (IL); Joeri VAN DER VLOET, Bornem (BE); Tal BAUMEL, Tel-Aviv (IL); Ksenya KVELER, Nesher (IL)

(21) Appl. No.: 18/963,390

(22) Filed: Nov. 27, 2024

(51) Int. Cl. G06F 40/166

(52) U.S. Cl. CPC G06F 40/166

(57) ABSTRACT

A method measures domain-meaningful edits between a generated text result and an edited text result. The generated text result is generated by a generative artificial intelligence model, and the edited text result is an edited version of the generated text result. Entities are extracted from the two text results using one or more name-entity algorithms, and each entity is linked to domain concepts in a domain-specific ontology. One or more edited areas are identified as one or more corresponding deltas between the two text results. One or more of the edits is determined to be domain-meaningful based on linkings of the entities to the domain concepts in the domain-specific ontology. A weight is assigned to each domain-meaningful edit based on the domain concepts in the domain-specific ontology. Aggregated edits are scored by aggregating the weights for each domain-meaningful edit to generate a meaningful change score.

### BACKGROUND

Evaluating the performance or results of an artificial intelligence (AI) system is challenging, even when ground truth is provided. The challenge is amplified when the AI system includes a generative AI model, such as an AI model that generates summaries of written text documents or otherwise generates new content. When it comes to generative AI models used in a healthcare domain, evaluating performance or results presents a compelling case, as mistakes in healthcare (e.g., summarizing medical records) can have life-threatening consequences.

### SUMMARY

In some aspects, the techniques described herein relate to a computerized method of measuring domain-meaningful edits between a generated text result and an edited text result, wherein the generated text result is generated by a generative artificial intelligence model and the edited text result is an edited version of the generated text result, the computerized method including: extracting entities from the generated text result and the edited text result using one or more name-entity algorithms; linking each entity of the generated text result and the edited text result to domain concepts in a domain-specific ontology; identifying one or more edited areas as one or more corresponding deltas between the generated text result and the edited text result; determining whether each edit between the generated text result and the edited text result are domain-meaningful based on linkings of the entities in the generated text result and the edited text result to the domain concepts in the domain-specific ontology; assigning a weight to each domain-meaningful edit between the generated text result and the edited text result based the domain concepts in the domain-specific ontology; and scoring aggregated edits between the generated text result and the edited text result by aggregating the weights for each domain-meaningful edit to generate a meaningful change score.

In some aspects, the techniques described herein relate to a computing system for measuring domain-meaningful edits between a generated text result and an edited text result, wherein the generated text result is generated by a generative artificial intelligence model and the edited text result is an edited version of the generated text result, the computing system including: one or more hardware processors; memory; one or more entity-concept linkers stored in the memory and executable by the one or more hardware processors, the one or more entity-concept linkers being configured to extract entities from the generated text result and the edited text result using one or more name-entity algorithms and to link each entity of the generated text result and the edited text result to domain concepts in a domain-specific ontology; an edit area detector stored in the memory and executable by the one or more hardware processors, the edit area detector being configured to identify one or more edited areas as one or more corresponding deltas between the generated text result and the edited text result; a meaningful change evaluator stored in the memory and executable by the one or more hardware processors, the meaningful change evaluator being configured to determine whether each edit between the generated text result and the edited text result are domain-meaningful based on linkings of the entities in the generated text result and the edited text result to the domain concepts in the domain-specific ontology; and a scoring processor stored in the memory and executable by the one or more hardware processors, the scoring processor being configured to assigning a weight to each domain-meaningful edit between the generated text result and the edited text result based the domain concepts in the domain-specific ontology and to score aggregated edits between the generated text result and the edited text result by aggregating the weights for each domain-meaningful edit to generate a meaningful change score.

In some aspects, the techniques described herein relate to one or more tangible processor-readable storage media embodied with instructions for executing on one or more processors and circuits of a computing device a process for measuring domain-meaningful edits between a generated result and an edited result, wherein the generated result is generated by a generative artificial intelligence model and the edited result is an edited version of the generated result, the process including: extracting entities from the generated result and the edited result using one or more name-entity algorithms; linking each entity of the generated result and the edited result to domain concepts in a domain-specific ontology; identifying one or more edited areas as one or more corresponding deltas between the generated result and the edited result; determining whether each edit between the generated result and the edited result are domain-meaningful based on linkings of the entities in the generated result and the edited result to the domain concepts in the domain-specific ontology; assigning a weight to each domain-meaningful edit between the generated result and the edited result based the domain concepts in the domain-specific ontology; and scoring aggregated edits between the generated result and the edited result by aggregating the weights for each domain-meaningful edit to generate a meaningful change score.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example generative artificial intelligence performance measurement system.

FIG. 2 illustrates internal components and processes of an example generative artificial intelligence performance measurement system.

FIG. 3 illustrates example operations for implementing a computerized method of measuring domain-meaningful edits between a generated text result and an edited text result.

FIG. 4 illustrates an example computing device for use in implementing the described technology.

### DETAILED DESCRIPTIONS

When a generative AI model generates output (e.g., a document summary), the output can be reviewed by a human to correct errors, clarify ambiguities, etc. A natural conclusion is that the more changes made by the human, the less accurate the output of the generative AI model was. If this were a reliable conclusion, the number of character or word changes alone might be a reliable measure of the performance of the generative AI model. However, this approach ignores the fact that some changes may not be meaningful in the domain in which the generative AI model is being used.

In artificial intelligence, a domain refers to a specific area of knowledge or a particular problem space where AI applications and solutions are applied. The domain defines the context and scope within which the AI system operates. Different domains have different characteristics, requirements, and challenges, and understanding these helps in designing and implementing effective AI solutions. Examples AI domains relating to content may include, without limitation:
Healthcare: AI applications in diagnosing diseases, predicting patient outcomes, and managing healthcare data
Finance: AI applications used in fraud detection, algorithmic trading, and risk management
Legal: AI applications used in document review and analysis, legal research, contract management, and e-discovery
Retail: AI applications for personalized recommendations, inventory management, and customer service
Autonomous Vehicles: AI technologies enabling self-driving cars, including perception, navigation, and decision-making
   Examples AI Domains Relating to Research May Include, without Limitation:
Natural Language Processing (NLP): AI technologies focused on understanding and generating human language, used in applications like chatbots and translation services
Computer Vision: AI techniques for interpreting and understanding visual information from the world, used in areas like facial recognition and object detection

Each domain comprises specialized knowledge and tailored AI solutions to address its unique challenges and goals. Accordingly, in some implementations, a domain-specific ontology is

In the healthcare domain, some changes may be clinically meaningful (“domain-meaningful”), while others may be merely stylistic or otherwise not clinically meaningful (“not-domain-meaningful”). Several examples are provided below that distinguish between clinically meaningful edits and not clinically meaningful edits, where a strikethrough denotes a deletion and an underline denotes an insertion.

Clinically-meaningful Edits

| Generated Text | | Edited Text |
|---|---|---|
| 1. “left upper lobe of the lung” | → | “left [symbol] lower lobe of the lung” |
| 2. “2 mm nodule” | → | “2 [symbol] cm nodule” |
| 3. “BRCA1 mutation” | → | “BRCA [symbol] 2 mutation” |

Not-clinically-meaningful Edits:

| Generated Text | | Edited Text |
|---|---|---|
| 1. “patient has kidney stone” | → | “patient has [symbol] renal stone” |
| 2. “patient fell after coming back | → | “patient fell after [symbol] |
| from a Hannukah party” | | returning from a [symbol] |
| | | Hanukkah party” |

The clinically meaningful edits listed above demonstrate how even small edits (e.g., a few words, a few characters) can result in extremely meaningful differences between the generated text and the edited text, thereby indicating a poorer performance of the generative AI model. In contrast, the not-clinically-meaningful edits listed above demonstrate how even larger edits can result in differences that are not meaningful in a clinical sense (e.g., kidney and renal may be viewed as synonyms, and the stylistic and typographical edits relating to the party do not have a meaningful impact on the patient's care). Accordingly, mere character and/or word edit rates, without more, are not reliable measures of generative AI model performance.

The described technology combines page, paragraph, character and/or word edit rates (collectively referred to herein as “text edit rates”) with an assessment of whether the text edits were meaningful in a given domain (e.g., a healthcare domain) to evaluate the performance of a generative AI model. In this manner, domain-meaningful edits may be interpreted as negative generative results, and not-domain-meaningful edits may be interpreted as neutral generative results. The described technology may employ a domain-specific ontology to programmatically distinguish between the domain-meaningful edits and the not-domain-meaningful edits.

An ontology is a formal data structure that represents knowledge about a specific domain (e.g., medical diseases). An ontology organizes concepts and properties of the concepts (e.g., attributes, hierarchical relationships) in a structured way, such as a graph, a table, a matrix, or other hierarchical structure. For example, the ontology may use a graph structure where nodes represent concepts and edges represent properties. Properties can include hierarchical relationships. For example, classes represent categories or types of objects in the domain and define a set of concepts with common characteristics. An individual, also known as an instance, represents a single, concrete object that belongs to a class. For example, a class (e.g., category) node may include one or multiple individual (e.g., instance) nodes within the class. In this example, the class may itself be an instance node of a higher class, and one or more of the instance nodes may also be a class node with further instance nodes within the class. Properties describe attributes of classes or individuals (e.g., data properties) and define relationships between them (e.g., object properties). For example, data properties specify characteristics or attributes of a class or individual and are associated with specific data values (e.g., numerical, textual, etc.). Object properties define relationships between individuals. Ontologies may be structured hierarchically, where classes are organized into a superclass-subclass (e.g., parent-child) relationship. The ontology may include logical statements or rules (e.g., axioms) that define how classes, individuals, and properties interact. For example, the ontology may require that every instance of the disease class have a relationship to at least one instance of the symptoms class.

For example, a healthcare ontology is a structured framework that defines and organizes medical concepts and their relationships. It is used to represent knowledge in the healthcare domain, enabling better data integration, sharing, and interoperability among different healthcare systems.

### Key Features of Healthcare Ontologies:

Concepts and Relationships: They define medical terms and their interconnections, such as symptoms, diagnoses, treatments, and procedures.
Semantic Interoperability: Ontologies help different healthcare systems understand and use each other's data by providing a common language.
Data Integration: They facilitate the integration of diverse data sources, such as electronic health records (EHRs), lab results, and patient histories.
Automated Reasoning: Ontologies support automated reasoning, allowing clinical systems to assist in decision-making processes.

Some healthcare ontologies may be characterized by a different combination of features. Examples of healthcare ontologies currently available include:
LinkBase—A medical ontology used by Microsoft
SNOMED Clinical Terms (SNOMED CT): A comprehensive clinical terminology used globally.
International Classification of Diseases (ICD): A classification system for diseases and health conditions.
Medical Subject Headings (MeSH): Used for indexing and searching biomedical literature.

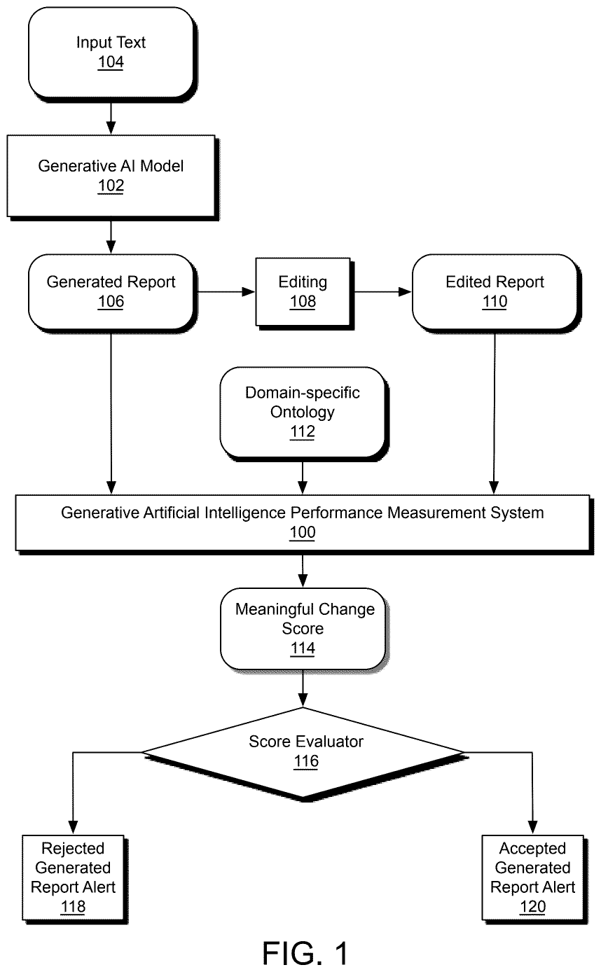

FIG. 1 illustrates an example generative artificial intelligence performance measurement system 100. A generative AI model 102 receives input data (e.g., input text 104 of a patient's medical records) and produces generated data (e.g., a generated report 106 summarizing the patient's medical records).

A generative AI model is capable of inputting more than text input and generating more than text output. As such, in other implementations, input data and generated/edited output having other formats may be employed, including, without limitation, images, audio, and/or video may be employed. In such implementations, the generative AI model 102 can respond to a prompt (e.g., “how do I fix a flat tire on a car?” and one or more photos of the flat tire, car, etc.) with a generated series of annotated image illustrating how to achieve the task. The generated annotations and images, for example, can be compared to an edited version of the annotations and images to identify edited areas that can then be scored against an ontology directed to automobile repair.

An editing process 108 is performed on the generated report 106 (e.g., a user or automated system edits the generated report 106) to yield an edited report 110. The generated report 106 and the edited report 110 are input to the generative artificial intelligence performance measurement system 100.

The generative artificial intelligence performance measurement system 100 evaluates the generated report 106 against the edited report 110 in the context of a domain-specific ontology 112. The generative artificial intelligence performance measurement system 100 extracts entities, their relations, and their assertions from the generated report 106 and the edited report 110 and links each entity of the reports with matching ontological concepts in the domain-specific ontology 112. The generative artificial intelligence performance measurement system 100 also identifies edited areas of the generated report 106 (relative to the edited report 110), which can provide a text edit rate measure.

One of the tasks in natural language processing (NLP) is named entity recognition (NER), which involves identifying and classifying entities mentioned in text into predefined categories. NER helps in extracting meaningful information from unstructured text and is used in various applications, such as information retrieval, question answering, and text summarization. Generally, in artificial intelligence, the term “entity” refers to an object or concept in input data that has distinct and meaningful representations within a given domain. Entities are used to model real-world objects, people, locations, or concepts that the AI system can recognize, understand, and manipulate. Example entities may include, without limitation, named entities (e.g., people, organization, locations), temporal entities (e.g., dates, times, durations), quantitative entities (e.g., numerical values, monetary values, medication dosages, sizes), product entities (e.g., products, brands, models), conceptual entities (medical concepts, technical terms), and event entities (e.g., significant occurrences or activities, such as a surgery, an injury, or a doctor's visit).

For every domain-specific concept/entity appearing in the edited areas, the generative artificial intelligence performance measurement system 100 determines whether the edits are domain-meaningful. Domain-meaningful edits are then weighted (e.g., weights are attached to links between nodes in a domain ontology graph) according to a predefined configuration and based on the relative positions of the entities of the generated report 106 and the entities of the edited report 110 in the domain-specific ontology 112. An aggregation of the weights (e.g., a sum) is output from the generative artificial intelligence performance measurement system 100 as a meaningful change score 114 that indicates a measurement of the domain-meaningful change introduced by the edits in aggregate (e.g., the higher the score of meaningful change, the poorer the performance of the generative AI model 102).

A score evaluator 116 analyzes the meaningful change score 114 to determine whether to accept the measured performance of the generative AI model 102 in generating the generated report 106. For example, if the editing process 108 results in enough domain-meaningful edits, subject to the weighting, the meaningful change score 114 may exceed a score threshold managed or input to the score evaluator 116, resulting in the issuance of an alert indicating a rejected generated report alert 118 based on the meaningful change score 114 failing to satisfy an acceptable performance condition (e.g., being less than the score threshold). On the other hand, if the editing process 108 does not result in significant domain-meaningful edits, subject to the weighting, the meaningful change score 114 may not exceed the score threshold managed or input to the score evaluator 116, resulting in the issuance of an alert indicating an accepted generated report alert 120 based on the meaningful change score 114 satisfying an acceptable performance condition (e.g., being less than the score threshold). Other results are possible, including multiple acceptable performance conditions (e.g., multiple score ranges or thresholds, each of which signal a different level of performance that a user or system can interpret to decide to accept, reject, and/or modify the report (e.g., accepted in the edited report 110 and rejecting the generated report 106).

In addition, the meaningful change score 114 can also be used to evaluate the generative AI model 102 itself, giving evidence that the generative AI model 102 needs further/better training, reprogramming, etc. The generated report 106 and/or the edited report 110 for failing meaningful change scores can be used as a target when retraining the generative AI model 102 (e.g., the generated report 106 can be a negative target and/or the edited report 110 can be a positive target).

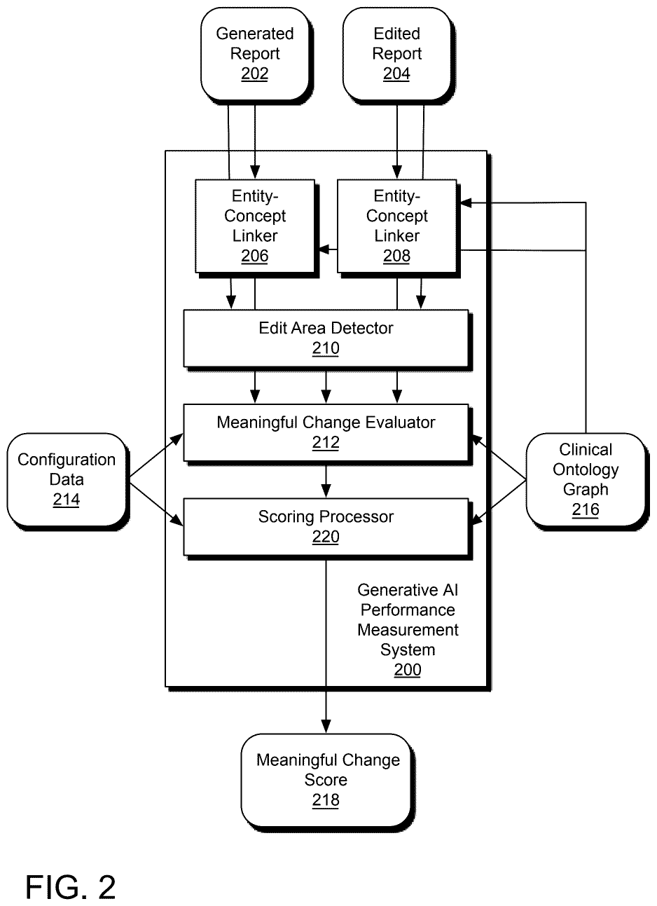

FIG. 2 illustrates internal components and processes of an example generative artificial intelligence performance measurement system 200. A generative AI model (not shown) receives input data (e.g., input text of a patient's medical records) and produces generated data (e.g., a generated report 202 summarizing the patient's medical records). A user and/or an electronic system edits the generated report 202, such as by correcting errors in the generated report 202, changing style, supplementing information, etc. A result of such editing tends to include domain-meaningful edits (e.g., correcting an error in a medication dosage level) and/or not-domain-meaningful edits (e.g., replacing a term with its clinical synonym). As such, it is not uncommon for the edited report to include both domain-meaningful edits and not-domain-meaningful edits, and yet, in one implementation, only the domain-meaningful edits tend to be illustrative of the performance for the generative AI model that generated the generated report 202. Furthermore, some domain-meaningful edits are more meaningful than others (e.g., an edit from “2 mm nodule” to “2 cm nodule” may be considered more meaningful than an edit from “2 mm nodule” to “2.01 mm nodule,” even though the latter edit exhibit a higher edit rate of three characters compared to 1 character of the former edit).

The generated report 202 is input to an entity-concept linker 206 of the generative artificial intelligence performance measurement system 200, and the edited report 204 is input to an entity-concept linker 208 of the generative artificial intelligence performance measurement system 200, although the same linker may be employed for both reports. In addition, a clinical ontology (e.g., in the form of a clinical ontology graph 216, in some implementations) is also input to each linker to provide domain-specific concepts and properties of the concepts (e.g., attributes, hierarchical relationships, assertions) in a structured way. Generally, in at least some implementations, the linkers extract entities and their relations and assertions from the generated report 202 and the edited report 204 and link each entity to a matching concept in the ontology. In this healthcare domain, for example, mapping the entities extracted from edited areas of the reports to clinical concepts in the clinical ontology graph 216 identifies whether an edit has been made to a clinical concept in the reports.

In some implementations, a TA4H (Text Analytics for Health) linker is employed, which is a cloud-based API service offered by Microsoft Azure AI Language that applies machine-learning intelligence to extract and label relevant medical information from unstructured texts such as doctor's notes, discharge summaries, clinical documents, and electronic health records. TA4H performs tasks like named entity recognition, relation extraction, entity linking, and assertion detection to uncover insights from the input text. TA4H helps healthcare providers improve patient care by extracting and organizing critical information from various medical documents. Other specific linkers may be employed.

In the context of TA4H, assertion detection refers to identifying and categorizing modifiers that provide context to medical entities within unstructured text. These modifiers help clarify the meaning of medical content, which is beneficial for accurate interpretation and decision-making.

There are four main categories of assertion detection in TA4H:
Certainty: Indicates the presence or absence of a concept and the level of certainty. For example, whether a symptom is definitely present, possibly present, or definitely absent.
Conditionality: Specifies whether the existence of a concept depends on certain conditions. For example, if a condition might develop in the future or only occurs under specific circumstances.
Association: Describes whether the concept is associated with the subject of the text (usually the patient) or someone else.
Temporal: Provides information about the timing of a concept, such as whether it occurred in the past, is occurring in the present, or is expected to occur in the future.

These assertion modifiers help provide a deeper understanding of the context in which medical concepts are mentioned, improving the accuracy and usefulness of the extracted information. In FIG. 2, the linkers extract entities and corresponding relations and assertions from the generated report 202 and the edited report 204 using one or more name-entity algorithms (e.g., via TA4H).

An edit area detector 210 identifies one or more areas of the generated report 202 that have been edited in the edited report 204, recording those edited areas as deltas (e.g., edited differences) between the two reports. Example edited areas refer to one or more character differences, one or more word differences, one or more paragraph differences, one or more page differences, etc. between the two reports. Such detection can be accomplished by comparing the text in the two reports to identify the edited areas (such as a “compare documents” feature in a word processor).

The extracted entities, relations, and assertions and the generated report 202 and the edited report 204 are input to a meaningful change evaluator 212, which, in some implementations, also receives configuration data 214 and a clinical ontology graph 216. The configuration data 214 includes meaningfulness rules for determining whether a given edited area includes a domain-meaningful change (e.g., a clinically-meaningful change) or a not-domain-meaningful change (e.g., a not-clinically-meaningful change). Generally, the meaningfulness rules indicate conditions that identify which edits are considered domain-meaningful and which edits are not considered domain-meaningful. Example meaningfulness rules in a healthcare context may include, without limitation:
A change of an entity to a synonym of that entity is not considered clinically meaningful.
A change of a clinical concept to a parent clinical concept of that entity is considered clinically meaningful
A change that has no impact on any clinical entities is not considered clinically meaningful.
Adding newlines is not considered clinically meaningful.

The configuration data 214 can also include other parameters. One such parameter can represent a meaningful change score threshold that distinguishes between acceptable generated text results and unacceptable generated text results based on the meaningful change score 218 corresponding to the generated report and output from the generative artificial intelligence performance measurement system 200. Other parameters may include, without limitation, multiple score thresholds that distinguish multiple ranges of meaningful changes and weights on graph links between nodes (see the discussion below regarding the clinical ontology graph 216). Generally, the configuration data 214 provides rules, parameters, and/or policies defining how the meaningful change evaluator 212 and the scoring processor 220 evaluate and score the edits between the generated report 202 and the edited report 204.

The clinical ontology graph 216 includes ontology data directed to the healthcare domain and, in some implementations, further includes weights assigned to various links between nodes in the clinical ontology graph 216. In other implementations, the weights may be stored in an external datastore, such as the configuration data 214 or other weight datastore, and then assigned to the clinical ontology graph 216 (e.g., by the meaningful change evaluator 212, the scoring processor 220, or some other operational component that can access the clinical ontology graph 216). In this manner, the weights can be adjusted according to specific contexts (e.g., different fields of healthcare, different demographical groups, updated clinical knowledge, and changes in methodology).

The scoring processor 220 receives as input a list of edited entities that have been identified as being domain-meaningful. In some implementations, the scoring processor 220 also receives input from the configuration data 214 and/or the clinical ontology graph 216. The scoring processor 220 assigns weights to each clinically meaningful edit identified by the meaningful change evaluator 212. In one implementation, the weights assigned to links between the mapped concepts (e.g., between the concepts of the clinical ontology graph 216 mapped to the originally generated entities of the generated report 202 and the concepts of the clinical ontology graph 216 mapped to the edited entities of the edited report 204) summed to develop an edit score (e.g., a meaningful edit weight) for each edit. Thereafter, the scoring processor 220 aggregates (e.g., sums) the edit scores corresponding to the full reports (or at least a subset of the full reports) to achieve a meaningful change score 218 for the reports.

The meaningful change score 218 represents a measure of how meaningful the edits to the generated report 202 (as exhibited in the edited report 204) are to the domain characterized by the clinical ontology graph 216. If the meaningful change score 218 for the reports satisfies an acceptable performance condition (e.g., is below a designated threshold), then the performance of the generative AI model can be considered acceptable. Otherwise, if the meaningful change score 218 for the reports fails to satisfy an acceptable performance condition (e.g., is below a designated threshold), then the performance of the generative AI model can be considered unacceptable, the generated report 202 is identified as rejected, and the generative AI model may be scheduled for revisions (e.g., training, reprogramming). The acceptable performance condition, threshold(s), etc. may be accessed from the configuration data 214 or some other datastore.

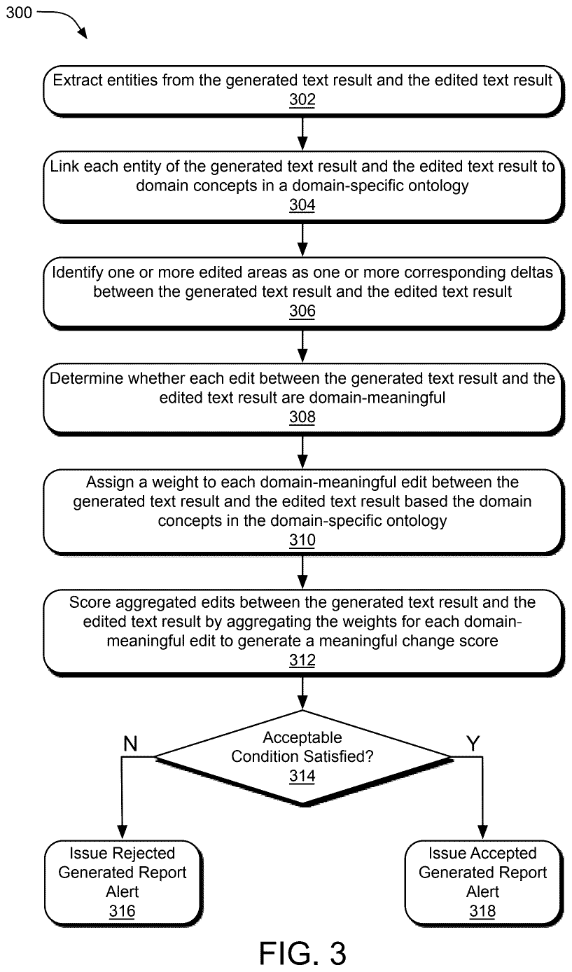

FIG. 3 illustrates example operations 300 for implementing a computerized method of measuring domain-meaningful edits between a generated text result and an edited text result. The generated text result is generated by a generative artificial intelligence model, and the edited text result is an edited version of the generated text result. An extracting operation 302 extracts entities from the generated text result and the edited text result using one or more name-entity algorithms. A linking operation 304 links each entity of the generated text result and the edited text result to domain concepts in a domain-specific ontology. An identification operation 306 identifies one or more edited areas as one or more corresponding deltas between the generated text result and the edited text result.

A determining operation 308 determines whether each edit between the generated text result and the edited text result is domain-meaningful based on linkings of the entities in the generated text result and the edited text result to the domain concepts in the domain-specific ontology. A weighting operation 310 assigns a weight to each domain-meaningful edit between the generated text result and the edited text result based on the domain concepts in the domain-specific ontology. A scoring operation 312 scores aggregated edits between the generated text result and the edited text result by aggregating the weights for each domain-meaningful edit to generate a meaningful change score.

Having computed the meaningful change score, a decision operation 314 evaluates the meaningful change score against one or more acceptable conditions. If an acceptable condition (or a requisite combination of acceptable conditions) is not satisfied, then an alerting operation 316 issues a rejected generated report alert indicating a possible performance problem with the generative artificial model. On the other hand, if an acceptable condition (or a requisite combination of acceptable conditions) is satisfied, then an alert operation 318 issues an accepted generated report alert indicating an acceptable performance by the generative artificial model.

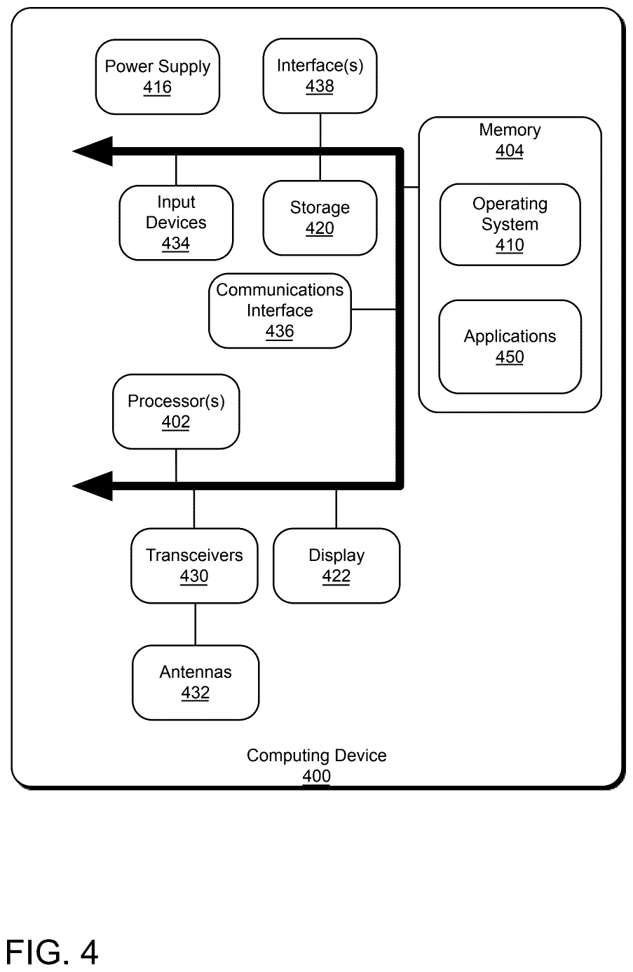

FIG. 4 illustrates an example computing device 400 for use in implementing the described technology. The computing device 400 may be a client computing device (such as a laptop computer, a desktop computer, or a tablet computer), a server/cloud computing device, an Internet-of-Things (IoT), any other type of computing device, or a combination of these options. The computing device 400 includes one or more hardware processor(s) 402 and a memory 404. The memory 404 generally includes both volatile memory (e.g., RAM) and nonvolatile memory (e.g., flash memory), although one or the other type of memory may be omitted. An operating system 410 resides in the memory 404 and is executed by the processor(s) 402. In some implementations, the computing device 400 includes and/or is communicatively coupled to storage 420.

In the example computing device 400, as shown in FIG. 4, one or more software modules, segments, and/or processors, such as applications 450, one or more entity-concept linkers, an edit area detector, a meaningful change evaluator, a scoring processor, a scoring evaluator, and other program code and modules are loaded into the operating system 410 on the memory 404 and/or the storage 420 and executed by the processor(s) 402. The storage 420 may store entities, concepts, relations, assertions, text results/reports, alerts, acceptable conditions, weights, nodes, links, graphs, ontologies, configuration rules, configuration parameters, configuration policies, edit areas, edits, and other data and be local to the computing device 400 or may be remote and communicatively connected to the computing device 400. In particular, in one implementation, components of a system for measuring domain-meaningful edits between a generated text result and an edited text result may be implemented entirely in hardware or in a combination of hardware circuitry and software.

The computing device 400 includes a power supply 416, which may include or be connected to one or more batteries or other power sources, and which provides power to other components of the computing device 400. The power supply 416 may also be connected to an external power source that overrides or recharges the built-in batteries or other power sources.

The computing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The computing device 400 may further include a communications interface 436 (such as a network adapter or an I/O port, which are types of communication devices). The computing device 400 may use the adapter and any other types of communication devices for establishing connections over a wide-area network (WAN) or local-area network (LAN). It should be appreciated that the network connections shown are exemplary and that other communications devices and means for establishing a communications link between the computing device 400 and other devices may be used.

The computing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The computing device 400 may further include a display 422, such as a touchscreen display.

The computing device 400 may include a variety of tangible processor-readable storage media and intangible processor-readable communication signals. Tangible processor-readable storage can be embodied by any available media that can be accessed by the computing device 400 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A computerized method of measuring domain-meaningful edits between a generated text result and an edited text result, wherein the generated text result is generated by a generative artificial intelligence model and the edited text result is an edited version of the generated text result, the computerized method comprising: extracting entities from the generated text result and the edited text result using one or more name-entity algorithms; linking each entity of the generated text result and the edited text result to domain concepts in a domain-specific ontology; identifying one or more edited areas as one or more corresponding deltas between the generated text result and the edited text result; determining whether each edit between the generated text result and the edited text result is domain-meaningful based on linkings of the entities in the generated text result and the edited text result to the domain concepts in the domain-specific ontology; assigning a weight to each domain-meaningful edit between the generated text result and the edited text result based on the domain concepts in the domain-specific ontology; and scoring aggregated edits between the generated text result and the edited text result by aggregating the weights for each domain-meaningful edit to generate a meaningful change score.

Clause 2. The computerized method of clause 1, wherein determining whether each edit between the generated text result and the edited text result is domain-meaningful comprises: applying defined meaningfulness rules to each edit.

Clause 3. The computerized method of clause 2, wherein the defined meaningfulness rules define conditions that identify which edits are considered domain-meaningful and which edits are not considered domain-meaningful.

Clause 4. The computerized method of clause 1, further comprising: determining whether the meaningful change score satisfies an acceptable performance condition for the generative artificial intelligence model.

Clause 5. The computerized method of clause 1, wherein the domain-specific ontology is in a form of a domain ontology graph in which individual weights are attached to graph links between graph nodes in the domain ontology graph.

Clause 6. The computerized method of clause 5, wherein assigning a weight to each domain-meaningful edit comprises: summing one or more individual weights on one or more graph links between relative positions of a first domain concept linked to an edited area of the generated text result and a second domain concept linked to a corresponding edited area of the edited text result.

Clause 7. The computerized method of clause 1, wherein scoring the aggregated edits between the generated text result and the edited text result comprises: summing the weights assigned to each domain-meaningful edit to generate the meaningful change score.

Clause 8. A computing system for measuring domain-meaningful edits between a generated text result and an edited text result, wherein the generated text result is generated by a generative artificial intelligence model and the edited text result is an edited version of the generated text result, the computing system comprising: one or more hardware processors; memory; one or more entity-concept linkers stored in the memory and executable by the one or more hardware processors, the one or more entity-concept linkers being configured to extract entities from the generated text result and the edited text result using one or more name-entity algorithms and to link each entity of the generated text result and the edited text result to domain concepts in a domain-specific ontology; an edit area detector stored in the memory and executable by the one or more hardware processors, the edit area detector being configured to identify one or more edited areas as one or more corresponding deltas between the generated text result and the edited text result; a meaningful change evaluator stored in the memory and executable by the one or more hardware processors, the meaningful change evaluator being configured to determine whether each edit between the generated text result and the edited text result are domain-meaningful based on linkings of the entities in the generated text result and the edited text result to the domain concepts in the domain-specific ontology; and a scoring processor stored in the memory and executable by the one or more hardware processors, the scoring processor being configured to assign a weight to each domain-meaningful edit between the generated text result and the edited text result based on the domain concepts in the domain-specific ontology and to score aggregated edits between the generated text result and the edited text result by aggregating the weights for each domain-meaningful edit to generate a meaningful change score.

Clause 9. The computing system of clause 8, wherein the meaningful change evaluator is configured to determine whether each edit between the generated text result and the edited text result is domain-meaningful by applying defined meaningfulness rules to each edit.

Clause 10. The computing system of clause 9, wherein the defined meaningfulness rules define conditions that identify which edits are considered domain-meaningful and which edits are not considered domain-meaningful.

Clause 11. The computing system of clause 8, further comprising: a score evaluator stored in the memory and executable by the one or more hardware processors, the score evaluator being configured to determine whether the meaningful change score satisfies an acceptable performance condition for the generative artificial intelligence model.

Clause 12. The computing system of clause 8, wherein the domain-specific ontology is in a form of a domain ontology graph in which individual weights are attached to graph links between graph nodes in the domain ontology graph.

Clause 13. The computing system of clause 12, wherein the scoring processor is configured to assign a weight to each domain-meaningful edit by summing one or more individual weights on one or more graph links between relative positions of a first domain concept linked to an edited area of the generated text result and a second domain concept linked to a corresponding edited area of the edited text result.

Clause 14. The computing system of clause 8, wherein scoring the aggregated edits between the generated text result and the edited text result by summing the weights assigned to each domain-meaningful edit to generate the meaningful change score.

Clause 15. One or more tangible processor-readable storage media embodied with instructions for executing on one or more processors and circuits of a computing device a process for measuring domain-meaningful edits between a generated result and an edited result, wherein the generated result is generated by a generative artificial intelligence model and the edited result is an edited version of the generated result, the process comprising: extracting entities from the generated result and the edited result using one or more name-entity algorithms; linking each entity of the generated result and the edited result to domain concepts in a domain-specific ontology; identifying one or more edited areas as one or more corresponding deltas between the generated result and the edited result; determining whether each edit between the generated result and the edited result is domain-meaningful based on linkings of the entities in the generated result and the edited result to the domain concepts in the domain-specific ontology; assigning a weight to each domain-meaningful edit between the generated result and the edited result based on the domain concepts in the domain-specific ontology; and scoring aggregated edits between the generated result and the edited result by aggregating the weights for each domain-meaningful edit to generate a meaningful change score.

Clause 16. The one or more tangible processor-readable storage media of clause 15, wherein determining whether each edit between the generated result and the edited result is domain-meaningful comprises: applying defined meaningfulness rules to each edit, wherein the defined meaningfulness rules define conditions that identify which edits are considered domain-meaningful and which edits are not considered domain-meaningful.

Clause 17. The one or more tangible processor-readable storage media of clause 15, further comprising: determining whether the meaningful change score satisfies an acceptable performance condition for the generative artificial intelligence model.

Clause 18. The one or more tangible processor-readable storage media of clause 15, wherein the domain-specific ontology is in a form of a domain ontology graph in which individual weights are attached to graph links between graph nodes in the domain ontology graph.

Clause 19. The one or more tangible processor-readable storage media of clause 18, wherein assigning of a weight to each domain-meaningful edit comprises: summing one or more individual weights on one or more graph links between relative positions of a first domain concept linked to an edited area of the generated result and a second domain concept linked to a corresponding edited area of the edited result.

Clause 20. The one or more tangible processor-readable storage media of clause 15, wherein scoring the aggregated edits between the generated result and the edited result comprises: summing the weights assigned to each domain-meaningful edit to generate the meaningful change score.

Clause 21. A system for measuring domain-meaningful edits between a generated text result and an edited text result, wherein the generated text result is generated by a generative artificial intelligence model and the edited text result is an edited version of the generated text result, the system comprising: means for extracting entities from the generated text result and the edited text result using one or more name-entity algorithms; means for linking each entity of the generated text result and the edited text result to domain concepts in a domain-specific ontology; means for identifying one or more edited areas as one or more corresponding deltas between the generated text result and the edited text result; means for determining whether each edit between the generated text result and the edited text result is domain-meaningful based on linkings of the entities in the generated text result and the edited text result to the domain concepts in the domain-specific ontology; means for assigning a weight to each domain-meaningful edit between the generated text result and the edited text result based on the domain concepts in the domain-specific ontology; and means for scoring aggregated edits between the generated text result and the edited text result by aggregating the weights for each domain-meaningful edit to generate a meaningful change score.

Clause 22. The system of clause 21, wherein the means for determining whether each edit between the generated text result and the edited text result is domain-meaningful comprises: means for applying defined meaningfulness rules to each edit.

Clause 23. The system of clause 22, wherein the defined meaningfulness rules define conditions that identify which edits are considered domain-meaningful and which edits are not considered domain-meaningful.

Clause 24. The system of clause 21, further comprising: means for determining whether the meaningful change score satisfies an acceptable performance condition for the generative artificial intelligence model.

Clause 25. The system of clause 21, wherein the domain-specific ontology is in a form of a domain ontology graph in which individual weights are attached to graph links between graph nodes in the domain ontology graph.

Clause 26. The system of clause 25, wherein the means for assigning a weight to each domain-meaningful edit comprises: means for summing one or more individual weights on one or more graph links between relative positions of a first domain concept linked to an edited area of the generated text result and a second domain concept linked to a corresponding edited area of the edited text result.

Clause 27. The system of clause 21, wherein the means for scoring the aggregated edits between the generated text result and the edited text result comprises: means for summing the weights assigned to each domain-meaningful edit to generate the meaningful change score.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computerized method of measuring domain-meaningful edits between a generated text result and an edited text result, wherein the generated text result is generated by a generative artificial intelligence model and the edited text result is an edited version of the generated text result, the computerized method comprising:
extracting entities from the generated text result and the edited text result using one or more name-entity algorithms;
linking each entity of the generated text result and the edited text result to domain concepts in a domain-specific ontology;
identifying one or more edited areas as one or more corresponding deltas between the generated text result and the edited text result;
determining whether each edit between the generated text result and the edited text result is domain-meaningful based on linkings of the entities in the generated text result and the edited text result to the domain concepts in the domain-specific ontology;
assigning a weight to each domain-meaningful edit between the generated text result and the edited text result based on the domain concepts in the domain-specific ontology; and
scoring aggregated edits between the generated text result and the edited text result by aggregating the weights for each domain-meaningful edit to generate a meaningful change score.

2. The computerized method of claim 1, wherein determining whether each edit between the generated text result and the edited text result is domain-meaningful comprises:
applying defined meaningfulness rules to each edit.

3. The computerized method of claim 2, wherein the defined meaningfulness rules define conditions that identify which edits are considered domain-meaningful and which edits are not considered domain-meaningful.

4. The computerized method of claim 1, further comprising:
determining whether the meaningful change score satisfies an acceptable performance condition for the generative artificial intelligence model.

5. The computerized method of claim 1, wherein the domain-specific ontology is in a form of a domain ontology graph in which individual weights are attached to graph links between graph nodes in the domain ontology graph.

6. The computerized method of claim 5, wherein assigning a weight to each domain-meaningful edit comprises:
summing one or more individual weights on one or more graph links between relative positions of a first domain concept linked to an edited area of the generated text result and a second domain concept linked to a corresponding edited area of the edited text result.

7. The computerized method of claim 1, wherein scoring the aggregated edits between the generated text result and the edited text result comprises:
summing the weights assigned to each domain-meaningful edit to generate the meaningful change score.

8. A computing system for measuring domain-meaningful edits between a generated text result and an edited text result, wherein the generated text result is generated by a generative artificial intelligence model and the edited text result is an edited version of the generated text result, the computing system comprising:
one or more hardware processors;
memory;
one or more entity-concept linkers stored in the memory and executable by the one or more hardware processors, the one or more entity-concept linkers being configured to extract entities from the generated text result and the edited text result using one or more name-entity algorithms and to link each entity of the generated text result and the edited text result to domain concepts in a domain-specific ontology;
an edit area detector stored in the memory and executable by the one or more hardware processors, the edit area detector being configured to identify one or more edited areas as one or more corresponding deltas between the generated text result and the edited text result;
a meaningful change evaluator stored in the memory and executable by the one or more hardware processors, the meaningful change evaluator being configured to determine whether each edit between the generated text result and the edited text result are domain-meaningful based on linkings of the entities in the generated text result and the edited text result to the domain concepts in the domain-specific ontology; and
a scoring processor stored in the memory and executable by the one or more hardware processors, the scoring processor being configured to assign a weight to each domain-meaningful edit between the generated text result and the edited text result based on the domain concepts in the domain-specific ontology and to score aggregated edits between the generated text result and the edited text result by aggregating the weights for each domain-meaningful edit to generate a meaningful change score.

9. The computing system of claim 8, wherein the meaningful change evaluator is configured to determine whether each edit between the generated text result and the edited text result is domain-meaningful by applying defined meaningfulness rules to each edit.

10. The computing system of claim 9, wherein the defined meaningfulness rules define conditions that identify which edits are considered domain-meaningful and which edits are not considered domain-meaningful.

11. The computing system of claim 8, further comprising:
a score evaluator stored in the memory and executable by the one or more hardware processors, the score evaluator being configured to determine whether the meaningful change score satisfies an acceptable performance condition for the generative artificial intelligence model.

12. The computing system of claim 8, wherein the domain-specific ontology is in a form of a domain ontology graph in which individual weights are attached to graph links between graph nodes in the domain ontology graph.

13. The computing system of claim 12, wherein the scoring processor is configured to assign a weight to each domain-meaningful edit by summing one or more individual weights on one or more graph links between relative positions of a first domain concept linked to an edited area of the generated text result and a second domain concept linked to a corresponding edited area of the edited text result.

14. The computing system of claim 8, wherein scoring the aggregated edits between the generated text result and the edited text result by summing the weights assigned to each domain-meaningful edit to generate the meaningful change score.

15. One or more tangible processor-readable storage media embodied with instructions for executing on one or more processors and circuits of a computing device a process for measuring domain-meaningful edits between a generated result and an edited result, wherein the generated result is generated by a generative artificial intelligence model and the edited result is an edited version of the generated result, the process comprising:
extracting entities from the generated result and the edited result using one or more name-entity algorithms;
linking each entity of the generated result and the edited result to domain concepts in a domain-specific ontology;
identifying one or more edited areas as one or more corresponding deltas between the generated result and the edited result;
determining whether each edit between the generated result and the edited result is domain-meaningful based on linkings of the entities in the generated result and the edited result to the domain concepts in the domain-specific ontology;
assigning a weight to each domain-meaningful edit between the generated result and the edited result based on the domain concepts in the domain-specific ontology; and
scoring aggregated edits between the generated result and the edited result by aggregating the weights for each domain-meaningful edit to generate a meaningful change score.

16. The one or more tangible processor-readable storage media of claim 15, wherein determining whether each edit between the generated result and the edited result is domain-meaningful comprises:
applying defined meaningfulness rules to each edit, wherein the defined meaningfulness rules define conditions that identify which edits are considered domain-meaningful and which edits are not considered domain-meaningful.

17. The one or more tangible processor-readable storage media of claim 15, further comprising:
determining whether the meaningful change score satisfies an acceptable performance condition for the generative artificial intelligence model.

18. The one or more tangible processor-readable storage media of claim 15, wherein the domain-specific ontology is in a form of a domain ontology graph in which individual weights are attached to graph links between graph nodes in the domain ontology graph.

19. The one or more tangible processor-readable storage media of claim 18, wherein assigning of a weight to each domain-meaningful edit comprises:
summing one or more individual weights on one or more graph links between relative positions of a first domain concept linked to an edited area of the generated result and a second domain concept linked to a corresponding edited area of the edited result.

20. The one or more tangible processor-readable storage media of claim 15, wherein scoring the aggregated edits between the generated result and the edited result comprises:
summing the weights assigned to each domain-meaningful edit to generate the meaningful change score.
